(19) United States
(12) Patent Application Publication
(10) Pub. No.: US 2010/0121833 A1
(43) Pub. Date: May 13, 2010

(54) SUSPICIOUS ACTIVITIES REPORT INITIATION

(76) Inventor: Michael Johnston, Strathclyde (GB)

Correspondence Address: BUTZEL LONG;IP DOCKETING DEPT, 350 SOUTH MAIN STREET, SUITE 300, ANN ARBOR, MI, 48104, US

(21) Appl. No.: 12/596,876

(22) PCT Filed: Apr. 21, 2008
(86) PCT No.: PCT/GB08/01398

§ 371 Date: Jan. 19, 2010

(51) Int. Cl. G06F 17/30

(52) U.S. Cl. 707/706; 707/812; 707/780; 707/748; 707/758; 707/E17.108; 707/E17.044

(57) ABSTRACT

There are serious concerns about the links between; terrorism, crime and money laundering that various Money Laundering Directives have come into being as well as other pieces of legislation. The outcome of investigating a SAR/Consent can be; seizure of assets, individuals being arrested, companies being subject to legal proceedings etc . . . Once the System has one or more SARs; then these SARs must be prioritised and worked to completion in a timely fashion. This present invention is a system and product to allow submitted SARs to be prioritised and worked to completion in a timely fashion using many different types of criteria. The system caters for the broad SAR user community; SAR Reporters such as Financial Service Providers (FSP), the Fraudulent Information gathering and coordinating Unit (FIU), law enforcement and other agencies. This user community may be using the system in a centralised or in a federated fashion or a combination of both.

### BACKGROUND OF THE INVENTION

Since 1970, in US the Bank Secrecy Act (31 C.F.R. 103) has been in place and financial institutions have a duty to report suspicious activities (SAR) to the government agency such as Financial Crimes Enforcement Network (FinCEN). However, USA PATRIOT Act places more responsibility on financial institutes to report suspicious activities or will be penalized.

In general, government agencies, financial institutions, merchants, and other institutes need to cooperate in combating terrorism, money laundering, drug dealing, fraud, identity theft, and/or other criminal activity involving banks and other financial institutions.

Methods to generate SAR's and detect online fraud by financial institutes have been developed. US2004/0215558A1 discloses a method of producing a suspicious activity reports by financial institute. The transaction processing device stores and configures information which generates SAR based on set instigation criteria which is not comprehensive to incorporate wide range of available information to meet every institutes set criteria. US20030220878 A1 discloses systems and methods for suspicious activity detection based on evaluating electronic value transfers and generating a report. WO2004/025540A2 discloses a method for detecting suspicious transactions. Automated method manages and assigns manual transactions and enables distribution of review information. Overall an automated system monitors financial transactions with collection of specified criteria e.g. sum >$2000, and send real-time feedback to terminals where transactions originate to disable the transaction. US2007/0028301A1 discloses a method of monitoring on line fraud activity by online businesses, banks, ISP's to provide security providers with fraud feed e.g. e-mail messages, where online information as first entity is received, analyzed, created as normalized data related to fraudulent activity in readable form and the data stored. US20050257261 A1 provides solutions for dealing with unethical uses of electronic mail, and in particular, with attempts to use email messages to facilitate online fraud. W02005/109225 discloses online fraud solution for dealing with unethical uses of electronic mail. The method gathers incoming email message, analyze, and categorize it as a fraudulent and also identify resource locator. WO2004097597 A2 discloses a method of confirming the validity of an identification presented by an individual in a financial transaction includes receiving transaction information at a transaction device that is usable to perform the financial transaction.

Both WO2005/093546 & US2005/0203881 disclose user behaviour information in database to detect unusual activity based on statistics-based intrusion detection (SBID) and rule-based intrusion detection (RBID).

Various fraudulent activity monitoring methods have been developed. US20020059130 A1 discloses method and apparatus to detect fraudulent activities within a network-based auction facility. US2006/0285665 discloses method and apparatus for fraud detection, based on voice monitoring. US2006/0041508A1 discloses a method and system for tracking fraudulent activities associated with web sites. The system includes a fraud tracking server which is connected to database, where server via communication module is linked to multiple client devices, and is able to identify potential spoof sites.

In addition, risk analysis is used for fraud detection. US2005/0267827A1 discloses a method and system to evaluate anti-laundering risk includes, (a) identifying a person, (b) a country associated with person, (c) financial product associated with person, (d) customer type, (e)risk rating set by predetermined criteria related such as country, financial product and customer type. Both US2003/0174823A1 & WO01/52518A1 disclose a fraud preventing system by (a) identifying one or more fraud indicators, (b) assign a weighted value to each of indicator, (c) detect if indicators are present in pending or past transactions associated with account, (d) set minimum risk level of indicators, (e) calculate cumulative risk level of indicators detected in past transactions associated with the account e.g. calling card and (f) exceeds predetermined threshold value, verify the request with account owner. WO2006/130819A2 shows a dynamic multidimensional risk weighted suspicious activities detection method in a stored database. Characteristics of subjects are put into mathematical model to produce risk values for each subject based on activity and background.

In US alone, FinCEN receives more than one million SARs per year. Henceforth, there is a need to utilize modern technology to coordinate SARs in timely and efficient manner.

FinCEN and other country institutes as SOCA in UK or any other single government agencies have limited resources. Also, financial institutes have no liaison amongst themselves. Often it is too late to punish criminals as damage has already been incurred. Henceforth, it is desirable to have a system in place which detects, coordinates and allows appropriate authorities to take preventative actions.

US2005/0102219A1 discloses a centralized computerized financial network to enable government agencies, financial institutions etc. to cooperate in combating terrorism, money laundering, drug dealing, fraud, identity theft, and/or other criminal activity involving banks and other financial institutions. A computerized United Crimes Elimination Network (“UCEN”) utilizes the infrastructure where data collection about SAR's is carried by an authorized person from financial institution, who can manually enter information, conduct search or upload information.

The centralized network can further request the financial institute to verify that they have filed SAR, share and report them to government agency. Also, an authorized government agency person can assess UCEN computer and retrieve SAR's, manually enter information conduct search or upload information. In addition, different level of creditability and accessibility can be assigned to different information sources i.e. government agencies may be given the highest level of creditability compared to lower level of creditability for financial institute or merchant. The UCEN database can use different pieces of information of different creditability levels for different purposes and applications. In summary, an authorized personnel of a government agency, a financial institution, a merchant, or other entities can log into the centralized UCEN computer system to check whether an individual or a organization has ever been identified as a suspect by anyone. If a match is found a message as email, fax or phone is send to report the suspect to government agency.

The network is a database which stores information on SAR's which can be shared and accessed by government agency, a financial institution, a merchant, or other entities. It instigates actions as messages in form of e-mails, fax or phone to government agencies. Also, information is manually loaded and manually matched by financial institute or government agencies own databases.

This type of system of network database has limitations as (a) many tasks are still manual, (b) no coordination between government agencies and financial institutes, (c) selection of appropriate agency to deal with particular SAR, (d) no means of filtering sensitive information, (e) no means of feedback to financial institutes on actions implemented or to be taken by government agencies and (f) means of linkage between government agencies.

The aim of this invention is to address above limitations

### SUMMARY OF INVENTION

An embodiment of the invention is a SAR's initiation system and product, which provides combination of few or all elements (a) searching, (b) matching, (c) matching engine, (d) matching robustness, (d) risk management, (e) meta-information, (f) work queuing, (g) pull button menu or and (h) push button menu

Another embodiment is a searching element system or method of combination of some or all of following sub-elements (a) main subject with associated information (b) an unlimited number of associated subjects with associated information, (b) allows single free text and free format search line, (c) allows bulk searching from a file (d) allow free text field e.g. for reason for suspicion, people are related, companies are related etc.

Another embodiment is a matching element system or method of combination of some or all of following sub-elements of (a) distinguishing between different type of subjects, (b) fuzziness when matching between main subjects, (c) exact matching when matching between associated subjects and (d) takes into account of combination of name, address, date of birth, reason for suspicious information such as: passport number, e-mail address, phone number, bank account number, other bank accounts from transaction, Other subjects in SAR list, Other matching subjects in SAR and use phrases.

Another embodiment is a matching engine element system or method of combination of some or all of following sub-elements of (a) main subject matching, (b) associated subject matching, (c) information matching, (d) transaction matching, (e) items in reason for suspicion matching, (f) subjects of interest list(s) matching and (g) reason for suspicion list(s) matching

Another embodiment is a matching engine matches a new SAR against the historical SARs (and against entries in the “Subject(s) of Interest List” and against entries in the “reason for Suspicion List”) and allows to filter the selection of historical SARs by a date range, and by state(s).

Another embodiment is a matching engine can match new SARs contained in the same batch file against each other.

Another embodiment is a matching robustness element system or method of combination of some or all of following sub-elements by (a) real time matching, (b) batch matching based on certain allocated times of days and allocated slots, (c) used by other users for matching “upon demand” and (d) storage of data lists of SAR as names and address stored in any order and or data stored as free format, each line is free fuzzy search line.

Another embodiment is a risk assessment element system or method of combination of some or all of following sub-elements by (a) overall score available to end user used for prioritising and used for risk assessment, (b) method of scoring, score when main subject match another main subject in a different SAR, associated subject match another associated subject in a different SAR, account number in an information field match another account number in a different SARs information field, account number in transaction match another account number in transaction in a different SARs transaction, item as passport number, mobile phone number, account number, e-mail address etc. in a SARs reason for suspicion field matches something in a different SARs reason for suspicious field, item as passport number, mobile phone number, account number, e-mail address etc. from your reason for suspicious list matches something in a SARs reason for suspicious field, subject from your subjects of interest list match a main or associated subject in a SAR.

Another embodiment is a meta-information element system or method of combination of some or all of following sub-elements for (a) overall risk score, (b) who owns SAR's/Consents, (c) expiry date for SAR/Consent, (d) due processing date for SAR/Consent, (e) security level, (f) quality of service header, (g) routing header

Another embodiment is a work queuing element system or method of combination of some or all of following sub-elements of (a) after SAR loading & matching, user is required to work allocation, (b) by default allocation setting via view my work, (c) by number of options for SAR allocation, turnover (highest first), type of match (any, SARs amatches against another SAR, SAR matches against item in “subject(s) of interest list”, SAR matches against item in “reason for suspicion list”), score or risk (highest first or lowest first) and age of SAR (oldest first or vice verse) and (d) SAR's allocated status, not assessed state, matched or not matched and no one else working

Another embodiment is a pull button based menu element system where user log on to find SAR's of interest through searching.

Another embodiment is push button menu element system or method combination of some or all of following sub-elements of where work is allocated to user (a) by turnover—to aid asset recovery by type, SAR's matching other SAR's, SAR's containing data matching subjects of interest list(s) and SAR's containing data matching reason for suspicious list(s), (b) by age, oldest to latest and latest to oldest and (c) by score, highest first, lowest last and lowest first, highest last

Another embodiment of the invention is a system and product that can be centralised database or federated database which offers individual case management system and customised system

Another embodiment is a system designed to be used by individuals, to use the system to interact with their software applications.
1. Individuals make use of the screens and functions provided through the user interface.
2. Software applications such as CRM systems etc . . . gain access to the same functions as users have access to through our interface onto this “business logic” layer. This system interface is a platform and technology independent interface. This “business logic” interface also provides for every function in the interface; a synchronous variant and an asynchronous variant. These software applications can be written in a completely different technology than this technology, may run on completely different operating systems to the ones this product runs on and are free to use synchronous and/or asynchronous access.
3. This system interacts with other software systems through a platform and technology independent interface. Thus this system does have neither operating systems nor software language interoperability issues to worry about.

### DETAILED DISCRIPTION

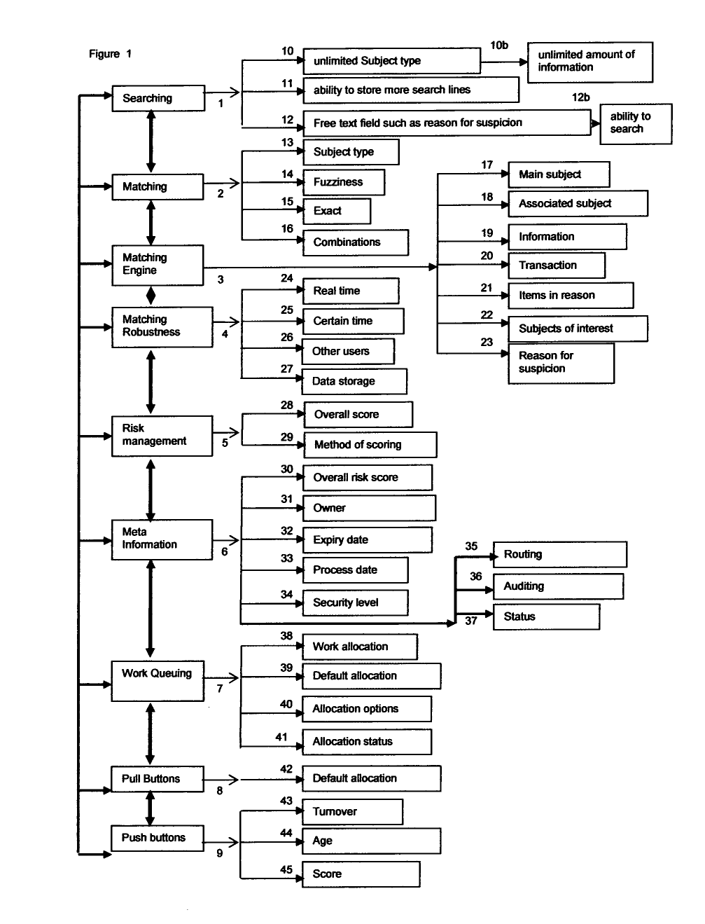

FIG. 1: SAR initiating system

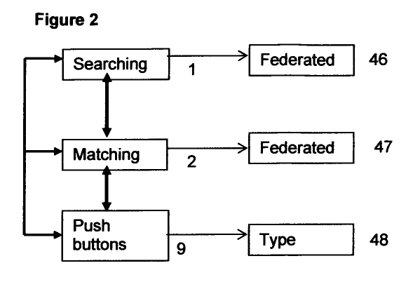

FIG. 2: SAR initiating system—federated

FIG. 1 shows system for SAR's and Consents initiation. SAR's and Consents are initiated by s combination and linkage of following elements searching (1), matching (2), matching engine (3), matching robustness (4), risk management (5), meta-information (6), work queuing (7), pull button menu (8) or and push button menu (9). The linkage of elements 1 to 9 can take in any order and number.

The searching element (1) itself is made of sub-elements unlimited number of subjects (10) and unlimited information (10b) about the subject type, ability to store many lines of search lines in a file (11), free text field (12) e.g. for reason for suspicion, people are related, companies are related etc., and the ability to search in free text (12b). The searching element (1) can be executed by use of any or all of sub-elements 10-12. Users may enter a single free format and free text fuzzy search line and obtain the results. Unsuccessful searches are stored and can be recalled and re-run at any time. Users may put one or more search lines in a file; each line is free format and free text with fuzziness. Users can then load this file in and view SARs that match one or more lines in the file. The results can be displayed showing the items that matched in the SAR or the search line from the file. Searching can be further constrained by; date range, SAR state(s) and SAR tag. The searching element performs local searching and federated searching. Local searching occurs where data that is being searched against is held in the local system. Federated searching (46) as shown in FIG. 2 occurs when the data one is searching against is held on another system.

The matching element (2) is executed by combination of few or all of sub-elements which are different type of subjects (13), fuzziness when matching between main subjects (14) exact¹ matching when matching between main or associated subjects (15) and takes into account of combination (16) of some or all of following: name, address, date of birth, reason for suspicious information such as: passport number, e-mail address, phone number, bank account number, other bank accounts from transaction, other subjects in SAR list, other matching subjects in SAR and use phrases. The matching element performs local matching and federated matching. Local matching occurs where data that is being matched against is held in the local system. Federated matching (47) as shown in FIG. 2 occurs when the data one is matching against is held on another system. The matching element (2) can be executed by use of any or all of sub-elements 13-16 and 47.

(1 Fuzziness is also supported for associated subjects. It is currently disabled to reduce the work load for users to a manageable level i.e. the amount of SARs in the Work Queuing system (7). It can be enabled when required by the end user.)

The system makes use of the specially reformatted data to speed up matching. In addition to the reformatting done in “SAR Searching” The system scans the “reason for suspicion” field and reformats special items. Every SAR has such a field which is free text. This field is used by the Reporting Institution to indicate why they submitted the SAR and to provide any additional information. This is a free text field.

The matching engine element (3) is executed by combination of few or all of sub-elements which are main subject matching (17), associated subject matching (18), information matching (19), transaction matching (20), items in reason for suspicion matching (21), subjects of interest list(s) matching (22) and reason for suspicion list(s) matching (23). The matching engine element (3) can be executed by use of any or all of sub-elements 17-23.

The matching robustness element (4) is executed by combination of few or all of sub-elements which are real time matching (24), batch matching based on certain allocated times of days and allocated slots (25), be used for on-demand matching by users (26) and storage of data (27) as lists of SAR as names and address stored in any order and or data stored as free format, each line is free fuzzy search line. The matching robustness element (4) can be executed by use of any or all of sub-elements 24-27. The sub-elements 24-27 allows matching robustness to match a new SAR against the historical SARs and allows to filter the selection of historical SARs by a date range, and by state(s).

Also these sub-elements 24-27 can match new SARs contained in the same batch file against each other.

The federated end-point managers (46 and 47) as shown in FIG. 2 take care of federated matching and searching requests between systems. It is configurable allowing an end user to specify; a) the other systems which may be contacted, b) the other systems it may receive requests from, c) the number of retry attempts, d) the time between retries (fixed or random within bounds). The end-point manager is able to discard duplicated federated match and search responses. A match returns a score (or indication of risk). If the end-point managers did not spot duplicates when; a) receiving a match score then it could end up counting a returned score more than once which would inflate the score and b) displaying duplicated search results.

Manage matching against existing and new SARs

From within The system one may;
1. Specify whether or not matching is enabled. This is checked each time the matching engine starts. If disabled the matching engine will go back to sleep.
2. Set the fuzziness. This is a value between 1 and 100. It is a percentage. 100 means “exact matching”, 1 means that only 1% needs to be the same for a match to occur. Fuzzy matching is only allowed when matching main subjects. “Exact matching” is used for associated subjects (fuzzy matching can be enabled for associated subjects by the end user, this is not recommended since it can make the number of SARs in the Work Queuing (7) system large), transactional information and reason for suspicion.
3. Define the states to be used when finding SARs to match against. The system uses OR to connect the set of states together. Only those existing SARs that have been in one of these states are considered when matching against new SARs.
4. Define date range. This looks at when SARs where loaded in. Only those existing SARs loaded in the specified date range are considered when matching against new SARs.
5. One may choose to ignore the end date. This is useful when one always wants to match against the very latest SARs including SARs being loaded in from the same file.

If matching has been enabled then The system looks to see if the same details have been spotted in different SARs;
1. Name with any combination of: address, date of birth, occupation, employer etc . . .
2. Reason for suspicion information such as; passport number, email address, mobile phone number, bank account numbers including those starting with a letter such as D/. When matching the reason for suspicion free text field the matching engine looks for the following (see the note at the end for an explanation of regular expressions);
   a. <anEmail>\w[-._\w]*\w@\w[-._\w]*\w\.\w{2, 10})+
   b. <aNumber>\d{6,})+
   c. <aLicense>[A-Z|a-z|0-9]+\d{5,}[A-Z|a-z|0-9]*)+
   d. <aPhone>\d{1,}-{0,1}\d{8,})+
   e. <misc>[A-Za-z0-9\-]*\d{3,}-\d{3,}[A-Za-z0-9\-]*)+
   f. <specialNumber>[A-Za-z]/\d{5,}
3. The system is not limited to the regular expressions used in bullet point 2 above. One may dynamically add ones own regular expressions and have them matched against the reason for suspicion free text field.
4. Bank account number and other bank account number from transactions are matched against.

5 types of matching when a SAR is matched against historical SARs;
1. Fuzzy matching for Main Subjects. One controls the % fuzziness. 100% means an exact match, 1% means that only one out of a hundred letters must match. Vowels can optionally be completely ignored.
2. Exact matching for Associated Subjects.
3. Regular expression matching of ID's within the “Reason for Suspicion” field. This field is free format text and one can have many things in here such as; bank account numbers, passport numbers, email addresses, etc . . .
4. Exact matching of ID's within the “Transaction” field. Here one usually has bank account numbers. Regular expression matching is also supported.
5. Exact matching of ID's within the “Information” fields. Here one usually has phone numbers. Regular expression matching is also supported

Regular Expressions

When a SAR is loaded into The system regular expressions are used to parse the reason for suspicion filed in the SAR header. Information found is then stored in special tables to be used when matching. This means that the parsing of a free text field only needs to occur once. Given this is a read-only field then this makes sense.

The following regular expressions are used (more details are given in our training course material, this section is just a short reminder, there are many regular expression tutorials on the web including http://www.regular-expressions.info/reference.html);

\w matches any letters or digits i.e. [a-zA-Z0-9]

* repeats the previous item zero or more times. Greedy, so as many items as possible will be matched before trying permutations with less matches of the preceding item, up to the point where the preceding item is not matched at all.

+ repeats the previous item once or more. Greedy, so as many items as possible will be matched before trying permutations with less matches of the preceding item, up to the point where the preceding item is matched only once.

\d matches any digit in the range 0 to 9

. matches any single character except line break characters \r and \n.

{n,} Where n>=1. This repeats the previous item at least n times. Greedy, so as many items as possible will be matched before trying permutations with less matches of the preceding item, up to the point where the preceding item is matched only n times.

The following regular expressions are looked for when parsing the reason for suspicion field in each SAR header;

An Email

\w[-._\w]*\w@\w[-._\w]*\w\.\w{2,10})+

A Number

\d{7,})+

A License

[A-Z|a-z|0-9]+\d{5,}[A-Z|a-z|0-9]*)+

A Phone

\d{1,}-{0,1}\d{8,})+

Miscalenous number

[A-Za-z0-9\-]*\d{3,}-\d{3,}[A-Za-z0-9\-]*)+

A special number

[A-Za-z]/\d{5,}

Manage matching new SARs against “Subjects of Interest”

Here one supplies a text file as input. This file may contain as many lines as you wish. Each line may contain anything in free text. One may;
1. Enable or disable this feature.
2. Upload the contents of e new file. Duplicates are ignored.
3. Edit (update and delete) lines from this file.
4. Add a new entry.

One may enter as much or as little as required. For example could just be a list of people's date of births, a just a list of surnames, or just a list of street names or some mix. It could even be for example the Bank of England Sanctions file or the USA OFAC file etc . . .

Each line is completely free format;
Is assumed to contain as much information known about a person such as: name, address and date of birth. Or could be company details.
Can put the information in any order.
Provides case insensitive searching.
Supports the wildcards: “*”, “_”, “[ ]” and “[̂]”.
Words must be separated by a space.
Currently support a maximum of 15 words per line. This can be extended if required.
The input file can have as many lines as required i.e. there is no limit on the number of lines in your input file.

Manage matching new SARs against “Reason for Suspicion”

Here one supplies a text file as input. This file may contain as many lines as you wish. Each line may contain anything in free text. One may;
1. Enable or disable this feature.
2. Upload the contents of e new file. Duplicates are ignored.
3. Edit (update and delete) lines from this file.
4. Add a new entry.

One may enter as much or as little as required. Expect this to be a list of key words such as; vat carousel, complicit in the deception, etc . . . Theses are compared against the contents of the “Reason for Suspicion” field in each newly loaded in SAR.

Each line is completely free format;
Is assumed to contain as much information known about a person such as: name, address and date of birth. Or could be company details.
Can put the information in any order.
Provides case insensitive searching.
Supports the wildcards: “*”, “_”, “[ ]” and “[̂]”.
Words must be separated by a space.
Currently support a maximum of 15 words per line. This can be extended if required.
The input file can have as many lines as required i.e. there is no limit on the number of lines in your input file.

“Phrasing” may be enabled or disabled. Consider vat carousel. If enabled then the carousel must come after carousel. If disabled than the match will occur if vat is found anywhere in the “Reason for Suspicion” field and if carousel if found anywhere in the “Reason for Suspicion” field.

The matching engine runs as an independently running background process. Every so often it wakes up looking for work. There are several types of matching that can be done, each may be individually enabled or disabled;
1. Matching against existing and new SARs; enable all or disable all or fine tune as below;.
   a. Match Main Subject (enable or disable)
   b. Match Associated Subject (enable or disable)
   c. Match Information (enable or disable)
   d. Match Transactions (enable or disable)
   e. Match Reason For Suspicion (enable or disable)
2. Matching new SARs against entries from the “Subjects of Interest Lists(s)”.
3. Matching new SARs against entries in the “Reason for Suspicion List(s)”.

Any such matches are stored in a database table. The user may view these results for any date period.

Manage Matching Engine through Windows Services

When one installs the matching engine it is installed as a Windows Service. Once installed it must be initially started. Once started the matching engine will take the time of day matching into account (if enabled) to decide whether or not to start. Thereafter it will wake up every so often as specified by you and will try to run.

One may; stop, pause and restart through the Windows Service interface. The matching engine is called “Matching Engine”. One may also configure the “Recovery” actions through the “Matching Engine” properties by selecting the Recovery tab. The default actions of “Take No Action” are set. These may be changed if required but care is required.

Manage Matching Engine “General Settings”

One may manage the matching engine through The system and through the Windows Services. Within The system one may manage the Matching Engine Service only it that service has been installed.

The settings in The system are used by the matching engine every time it wakes up and looks for work. From within The system one may;
1. Specify whether or not Time of Day matching is enabled. This is checked each time the matching engine starts. If enabled the Matching Engine will check that the current time is within the specified Time of Day for matching to occur. The start hour and end hour are in 24 hour clock.
2. Specify the number of SARs to allocate to users in one go. Users are given SARs that are; 1) In the “Not Assessed” state and 2) have been matched against other SARs and 3) that no one else is working.
3. Specify the “chunk size”. Each time the matching engine performs matching it will grab a chunk of new unprocessed SARs. The number to grab is defined in this “chunk size”. This is done so that the matching engine does not use too many CPU and RAM resources when matching.
4. Specify how often to wake up looking for work. This is in minutes. If the matching engine is already running it will not try to run. Only one instance of the matching engine ever runs at one time.

The risk assessment element (5) is executed by combination of few or all of sub-elements which are overall score (28) available to end user used for prioritising and used for risk assessment, method of scoring (29), score when main subject match another main subject in a different SAR, associated subject match another associated subject in a different SAR, account number in an information field match another account number in a different SARs information field, account number in transaction match another account number in transaction in a different SARs transaction, item as passport number, mobile phone number, account number, e-mail address etc. in a reason for suspicious list matches something in a different SARs reason for suspicious field, item as passport number, mobile phone number, account number, e-mail address etc. from your reason for suspicious list matches something in a different SARs reason for suspicious field, subject from your subjects of interest match a main or associated subject in a SAR. The risk assessment element (5) can be executed by use of any or all of sub-elements 28-29.

Scoring and risk. One may assign a score to each type of matching. When a SAR is matched the scores for each type of matching are added up. This total score could be interpreted as an indication of risk. Each score must be greater than or equal to one.

One may assign a score to each of;
1. Score/risk when a main subject matches another main subject in a different SAR.
2. Score/risk when an associated subject matches another associated subject in a different SAR.
3. Score/risk when something in a transaction matches the same thing in a different SAR's transaction e.g. account number.
4. Score/risk when something in an information field matches the same thing in a different SAR's information field e.g. passport number.
5. Score/risk when items such as; passport numbers, mobile phone numbers, account numbers, email addresses etc . . . in a reason for suspicion field matches another item in a different SARs reason for suspicion field.
6. Score/risk when items such as; passport numbers, mobile phone numbers, account numbers, email addresses etc . . . from your reason for suspicion list matches something in a SARs reason for suspicion field.
7. Score/risk when a subject from your subjects of interest list matches a main or associated subject in a SAR.

This score is then made available to end users. Allowing them to prioritise based on amongst other things score/risk.

The meta-information element (6) is executed by combination of few or all of sub-elements which are overall risk score (30), who owns SAR's/Consents—owner (31), (c) expiry date (32) for SAR/Consent, due processing date (33) for SAR/Consent and security level (34), (35) Routing, (36) Auditing, and (37) Status. The meta-information element (6) can be executed by use of any or all of sub-elements 30-37.

The system also stores meta information about each specially formatted search line such as;
When was it stored in system. Thus allowing the searching/matching to take date of entry into account.
What is the overall state of this SAR. Thus allowing the searching/matching to take a SAR's state into account.
What tag has the user associated with this SAR. Thus allowing the searching/matching to take a SAR's tag into account.
The overall risk/score for this SAR. Thus allowing the searching/matching to take a SAR's score into account.

The work queuing element (7) is executed by combination of few or all of sub-elements which are work allocation (38) i.e. after SAR loading & matching, user is required to work allocation, default allocation (39) setting via view my work, by number of options for SAR allocation (40), turnover (highest first), type of match (any, SARs that match other SARs, SARs that contain matches against entries in the subject of interest list(s), SARs that contain matches against entries in the reason for suspicion list(s)), score or risk (highest first or lowest first) and age of SAR (oldest first or vice verse) and SAR's allocated status (41), not assessed state, matched or not matched and no one else working. The work queuing element (7) can be executed by use of any or all of sub-elements 38-41.

Get Work Using Default “Allocation Settings”

To get some work one may simply press the “View My Work” button using the default “allocation settings”. By default one is allocated the SARs that can contribute to the highest level of asset recovery first.

Get Work Using NON Default “Allocation Settings”

One has a number of options when being allocated SARs; there is the type of match, the turnover, the score and the age of the SARs. The turnover is optional, one may wish to prioritise say the score or risk or the age of outstanding SARs over the turnover.

Thus one may choose to be allocated SARs based on;
1. Turnover (highest first). This is optional and can be disabled.
2. Type of match (any, SARs that match other SARs, SARs that contain people/companies in the “subjects of interest” list, SARs whose reason for suspicion field contains entries in the “reason for suspicion” list).
3. The score or risk (highest or lowest first).
4. The age of the SAR (oldest first or youngest first).

### SOME EXAMPLES

1. User could opt for; “SARs that match other SARs” where the highest risk and oldest are allocated first without taking turnover into account.
2. User could opt for; “SARs that match other SARs” where turnover is taken into account first and then the highest risk and youngest are taken into account.
3. User could opt for; “SARs that match other SARs” where turnover is taken into account first and then the youngest and highest risk are taken into account.

Note that (2) and (3) from above differ. They both take turnover into account. Once turnover has been taken into account;
Then (2) goes for highest score, when two or more SARs have the same score than they are ordered by youngest first.
Then (3) goes for youngest, when two or more SARs have the same age than they are ordered by highest score first.

SARs allocated to you

The number of SARs allocated to you at one time is controlled through the Admin application. You are given SARs that are;
1. In the “Not Assessed” state.
2. And have been matched against other SARs.
3. And that no one else is working.

A pull button based menu element (8) is used in system where user log on to find SAR's of interest through searching which is default option (42)

The push button menu element (9) is executed by combination of few or all of sub-elements which are turnover (43)—to aid asset recovery by type (48), SAR's matching other SAR's, SAR's containing data matching entries in the subjects of interest list(s) and SAR's containing data matching entries in the reason for suspicious list(s), by age (44), oldest to latest and latest to oldest and by score (45), highest first, lowest last and lowest first, highest last. The push button menu element (9) can be executed by use of any or all of sub-elements 43-45.

As SARs are loaded in matching automatically occurs. If there are any matches then these are available for users to work through. This is an example of “push” technology where The system allocates work for the user. As apposed to a “pull” technology where the user has to search for SARs to work through. In fact The system offers both “push” and “pull”, letting the user choose which one is best for them.

### Example 1

When a user performs a search in the system they enter a free text string. The information such as a person's name, date of birth, occupation, address, post code etc . . . can be entered in any order. To speed up this type of searching The system reformats the data contained in a SAR.

Reformat input and preserve relationships. A snippet from a SAR is shown in an example ACSII (ASCII and XML are supported. In the examples only ASCII versions are shown) format below;

MAIN|PERSON|PERSON|AMOAKING|Richard|Raymind∥Feb. 26, 1974|Owner of Business∥Male|

MAIN|PERSON|ADDRESS|Home|N|119 Brocklesby Road|South Norwood|London|∥SE25 4LB

MAIN|PERSON|ADDRESS|Home|N|9 BROCKLESBY ROAD|∥SOUTH NORWOOD|LONDON|SE25 4LB

MAIN|PERSON|ADDRESS|Home|Y|FLAT 27 HARDEN HOUSE|MCNEIL ROAD|∥CAMBERWELL|SE5 8PP

ASSOCIATED|PERSON|PERSON|MOHAMED|Omar|Hassan∥Aug. 20. 1964|∥Male|NATIONALITY—UK

ASSOCIATED|PERSON|ADDRESS|Home|Y|120 MILE END ROAD|LONDON∥∥E1 4UN

ASSOCIATED|PERSON|ADDRESS|Other|N|40 CUFF POINT|COLUMBIA ROAD|LONDON|∥E2 7PP

ASSOCIATED|COMPANY|COMPANY|CHOICE MONEY TRANSFER|∥∥

ASSOCIATED|PERSON|ADDRESS|Home|Y|120 MILE END ROAD|LONDON∥∥E1 4UN

The system joins these relationships up in a special search table. The system joins people/companies up with their related information such as addresses, transactions or regular expressions found in a special field called the “reason for suspicion” field. For example;

MAIN|PERSON|PERSON|AMOAKING|Richard|Raymind∥Feb. 26, 1974|Owner of Business∥Male|

MAIN|PERSON|ADDRESS|Home|N|119 Brocklesby Road|South Norwood|London|∥SE25 4LB

MAIN|PERSON|ADDRESS|Home|N|9 BROCKLESBY ROAD|∥SOUTH NORWOOD|LONDON|SE25 4LB

Is stored as where the relationship between subject and in this example address is created:

AMOAKING Richard Raymind Feb. 26, 1974 Owner of Business Male 119 Brocklesby Road South Norwood London SE25 4LB

AMOAKING Richard Raymind Feb. 26, 1974 Owner of Business 9 BROCKLESBY ROAD SOUTH NORWOOD LONDON SE25 4LB

This speeds up searching and matching. Suppose the user searches for; Raymind Brocklesby AMOAKIN. The system simply checks each appropriate search line looking for one or more that have all 3 words.

Wildcarding such as R_ym[i-z]nd and 26/07/197[0-9] can be used. A user can also load in a file of search lines. The system will return the results showing which SARs match entries from the search lines in the search file.

### Example 2

The system takes this file and returns the results for each line from this file. Consider these examples below;
Michael Johnston Jul. 18, 1965 42 Forest View Lane Edinburgh
Sep. 12, 1965 Peter Glasgow Jones
London Smith Carron Paul
Ashok

The first lines returns all SARs where there is a person called “Michael Johnston” who was born on “Jul. 18, 1965” and has lived at “42 Forest View Lane Edinburgh”.

The second line returns all SARs where there is a person called “Peter Jones” who was born on “Sep. 9, 1965” and is living in “Glasgow”.

The third line returns all SARs where there is a person called “Paul Smith” who lives in “Carron” street in “London”.

The fourth line returns all SARs with a person or company called Ashok.

### Example 3

The system takes this file and returns the results for each line from this file. Consider this example below;
Michael J_hnston Jul. 12, 1961 Edinburgh
Sep. 12, 19[56]5 Peter Glasgow Jones
Asho[̂]

In the first line “J_hnston” will match against anything that starts with “J” is followed by any single character and ends with “hnston”. Such as “Johnston”, “Jahnston”.

In the second line one is looking for a Peter Jones living in Glasgow who was born on Sep. 12, 1955 or Sep. 12, 1965.

In the third line one is looking for a person whose name starts Asho but does not end in k. Thus Ashok would not match but Ashol does match.

### Example 4

A matching engine can match new SARs contained in the same batch file against each other. Suppose one has a file of say 2,000 SARs. The matching engine can spot matches in the SARs contained in this batch file.

1-36. (canceled)

37. An apparatus adapted to process and store data relating to suspicious activity, the apparatus comprising:
inputting means for inputting the data;
a memory for storing the data; and
a processor for processing the data and storing the data to memory,
wherein the processor is adapted to match the inputted data with existing data which has previously been stored to memory or existing data stored at another source.

38. The apparatus as claimed in claim 37, wherein the processor is adapted to access existing data stored at a source external to the apparatus to perform the match.

39. The apparatus as claimed in claim 37, wherein the inputting means is adapted to allow the inputting of a batch of data relating to suspicious activity and the processor is adapted to match data being added with data contained in the batch of data.

40. The apparatus as claimed in claim 37, wherein the processor is adapted to match the inputted data with existing data at the time of adding the inputted data.

41. The apparatus as claimed in claim 37, wherein the apparatus is adapted to allow a user to specify the matching criterion used by the processor, and wherein the matching criterion comprises one or more of a main subject, an associated subject, a financial account number, and a subject identifier.

42. The apparatus as claimed in claim 41, wherein the subject identifier is a passport number, a telephone number, or an email address.

43. The apparatus as claimed in claim 37, wherein the apparatus is adapted to match data in a first field of the inputted data with data in a second field of the existing data.

44. The apparatus as claimed in claim 37, wherein the processor is adapted to perform an exact match of inputted data with existing data or to match data that meets one or more similarity criteria.

45. The apparatus as claimed in claim 44, wherein the one or more similarity criteria each comprise a fuzzy start or end or text, phrasing, data proximity, status, a date or date range, synonyms, inflectional wording or geographical proximity.

46. The apparatus as claimed in claim 37, wherein the apparatus is adapted to assign a score to the inputted data based upon the degree of matching with existing data.

47. The apparatus as claimed in claim 46, wherein the score is determined using one or more factors comprising a financial value relating to the inputted data, a total financial value relating to both the inputted data and matched existing data, the type of match or the age of the suspicious activity.

48. The apparatus as claimed in claim 46, wherein the apparatus is adapted to prioritize the inputted data based upon the degree of matching with existing data.

49. The apparatus as claimed in claim 48, wherein the apparatus is adapted to prioritize the inputted data based upon the assigned score.

50. The apparatus as claimed in claim 37, wherein the apparatus is adapted to transmit or display matched data to one or more users, the matched data being transmitted or displayed in the order of the assigned score, asset value, age or status.

51. The apparatus as claimed in claim 37, wherein the apparatus is adapted to categorize matched data by how the data is matched.

52. The apparatus as claimed in claim 51, wherein the apparatus is adapted to transmit or display matched data to a user based on the category of the matched data and a designation of the user.

53. The apparatus as claimed in claim 37, wherein the inputting means is adapted to receive structured data, and the processor is adapted to process the structured data to denormalise the data.

54. The apparatus as claimed in claim 53, wherein denormalising the data comprises generating one or more data strings corresponding to the structured data.

55. The apparatus as claimed in claim 53, wherein denormalising the data includes preserving the relationships of the structured data.

56. The apparatus as claimed in claim 54, wherein the processor is adapted to delete duplicate data strings.

57. The apparatus as claimed in claim 37, wherein the inputting means is adapted to receive unstructured free text data.

58. The apparatus as claimed in claim 57, wherein the processor is adapted to use regular expressions to extract tokens from the unstructured free text data.

59. The apparatus as claimed in claim 58, wherein the processor is adapted to delete duplicate tokens.

60. The apparatus as claimed in claim 37, wherein the apparatus includes a search engine for searching existing data, and wherein the search engine is adapted to search structured or unstructured data.

61. The apparatus as claimed in claim 60, wherein the search engine is adapted to denormalise the data by generating one or more data strings corresponding to the structured data.

62. The apparatus as claimed in claim 61, wherein denormalising the data includes preserving the relationships of the structured data.

63. The apparatus as claimed in claim 37, wherein the apparatus is provided on a network comprising one or more financial service providers, a government agency and a plurality of investigative agencies, and the network is adapted to allow the one or more financial service providers to generate and transmit one or more of a suspicious activity report and a consent request to the government agency.

64. The apparatus as claimed in claim 63, wherein the network is adapted to allow the government agency to process a suspicious activity report or a consent request received from the one or more financial service providers and then transmit the suspicious activity report or the consent request to one or more of the plurality of investigative agencies.

65. The apparatus as claimed in claim 63, wherein the network is adapted to allow the plurality of investigative agencies to share data relating to a suspicious activity report or a consent request.

66. The apparatus as claimed in claim 63, wherein the network is adapted to allow one or more of the plurality of investigative agencies to generate an investigative report relating to a suspicious activity report or a consent request and to transmit the investigative report to the government agency, and wherein the network is adapted to allow the government agency to transmit the investigative report received from the one or more of the plurality of investigative agencies to the one or more financial service providers.

67. The apparatus as claimed in claim 66, wherein the network is adapted to filter the investigative report before transmittal to the financial service provider.

68. The apparatus as claimed in claim 63, wherein the network includes one or more closed user groups, and wherein the network is adapted to transmit data relating to one or both of a suspicious activity report or a consent request and an investigative report to a closed user group.

69. The apparatus as claimed in claim 63, wherein the network comprises the proprietary computer systems, databases or files of one or more of the financial service providers and plurality of investigative agencies.

70. The apparatus of claim 63, wherein the government agency is the Financial Crimes Enforcement Network (FinCEN).

71. An apparatus adapted to process and store data relating to a suspicious activity, the apparatus comprising:
inputting means for inputting the data;
a memory for storing the data; and
a search engine for searching stored data,
wherein the search engine is adapted to denormalise the data to generate one or more data strings corresponding to the structured data and to subsequently carry out a search of the or each data string.

72. The apparatus as claimed in claim 71, wherein the search engine is adapted to search structured or unstructured data.

73. The apparatus as claimed in claim 71, wherein denormalising the data includes preserving the relationships of structured data.

74. The apparatus as claimed in claim 71, wherein the search engine is adapted to perform an exact search of existing data or to find data that meets one or more similarity criteria.

74. The apparatus as claimed in claim 74, wherein the one or more similarity criteria each comprise a fuzzy start or end or text, phrasing, data proximity, status, a date or date range, synonyms, inflectional wording or geographical proximity.

75. The apparatus as claimed in claim 71, wherein the apparatus is provided on a network comprising one or more financial service providers, a government agency and a plurality of investigative agencies.

76. The apparatus of claim 75, wherein the government agency is the Financial Crimes Enforcement Network (FinCEN).
